(19) United States
(12) Patent Application Publication
(10) Pub. No.: US 2003/0222358 A1
(43) Pub. Date: Dec. 4, 2003

(54) Floated mist generating humidifier

(76) Inventors: Jui-Yang Li, Yung Kang City (TW); Hsin-Chin Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/157,143

(22) Filed: May 30, 2002

(51) Int. Cl. B01F 3/04

(52) U.S. Cl. 261/120

(57) ABSTRACT

A floated mist generating humidifier includes a housing member, and a mist generating device. The mist generating device is disposed in a holding room of the housing, which has several through holes communicating with the holding room. The holding room has an upper opening. The mist generating device can generate, and send out, mist when coming into contact with water. The housing member is constructed such that the humidifier can float on water with the through holes being at least partially submerged under surface of the water; thus, the mist generating device is activated to send out mist through the tipper opening to the atmosphere when the humidifier floats on water.

### BACKGROUND OF THE INVENTION

The present invention relates to a mist generating humidifier and more particularly a mist generating humidifier which can float on water so as to move up and down with the water level, and which is made in such a manner that it has decorating function besides the humidifying one.

Referring to FIG. 5, a conventional mist generating humidifier includes a main body 3, a sucker 31, a water level detecting device 32, and a mist outlet 33. The main body 3 is disposed in a container having water contained therein with the water level detecting device 32 floating on the water in the container; the main body 3 can be made to sink to the bottom of the container or disposed a distance from the bottom by means of making the sucker 31 stick to the inner side of the container. The water level detecting device 32 moves up and down with the water level to detect the water level, and will activates the main body 3 to generate mist when the water level is higher than a predetermined height. Thus, mist is sent to outside through the mist outlet 33. When the water level becomes lower than the predetermined height, the detecting device 32 will make the main body 3 stop generating mist.

Such humidifier is usually disposed in a water container for humidifying the room, and the main body 3 is usually hidden so as not to be seen because the same is provided with a monotonous shape. Such humidifier can also be disposed in an aquarium glass container for humidifying the room as well as decorating the aquarium with the mist that comes out from the outlet 33 and through surface of water of the aquarium.

However, the mist generating humidifier is found to have disadvantages as followings:

1. The user has to hide the main body in certain place for preventing the monotonous appearance of the same from badly affecting the look of the room, costing him time and labor.

2. When a humidifier without a sucker is disposed in water of relatively great depth, the mist that comes out of the mist outlet 33 can't be sent beyond the surface of the water successfully because the distance between the outlet 33 and the surface of the water is too long. Consequently, the user has to put objects under the same to dispose the same at an elevated position.

3. When the water level becomes lower than the predetermined height, the user has to add water to the container or adjust the position of the humidifier in relation to the water of the container, otherwise the same will stop generating mist.

### SUMMARY OF THE INVENTION

Therefore, it is a main object of the present invention to provide a mist generating humidifier which can float on water so that change of the water level of the water can't affect the functioning thereof.

It is another object of present invention to provide the mist generating humidifier in such a manner that it has decorating function besides the humidifying one.

The humidifier can generate, and send out, mist as long as there is sufficient water level for the same to float on. Thus, the user doesn't have to spend time in adjusting the position of the humidifier when the water level changes. The humidifier is entertaining and pleasant to look at because it can make circular movement, and can be presented with particular designs and colors.

### BRIEF DESCRIPTION OF DRAWINGS

The present invention will be better understood by reference to the accompanying drawings, wherein:

FIG. 1 is ail exploded perspective view of the floated mist generating humidifier of the present invention.

FIG. 2 is a cross-sectional view of the present floated mist generating humidifier.

FIG. 3 is a cross-sectional view of the floated mist generating humidifier of another embodiment.

FIG. 4 is a view showing the use of the present floated mist generating humidifier.

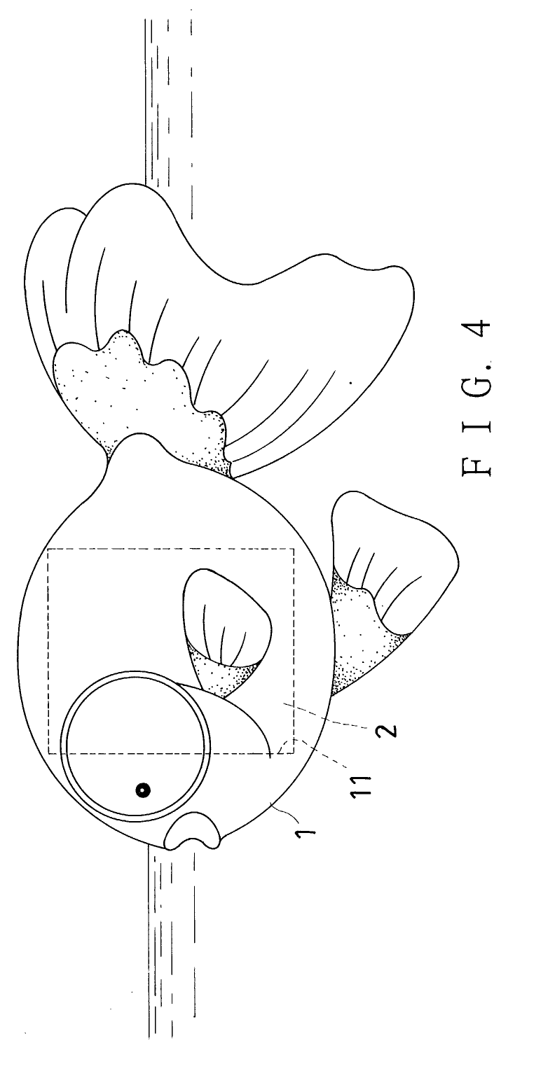

FIG. 5 is a view showing the use of the conventional mist generating humidifier in the Background.

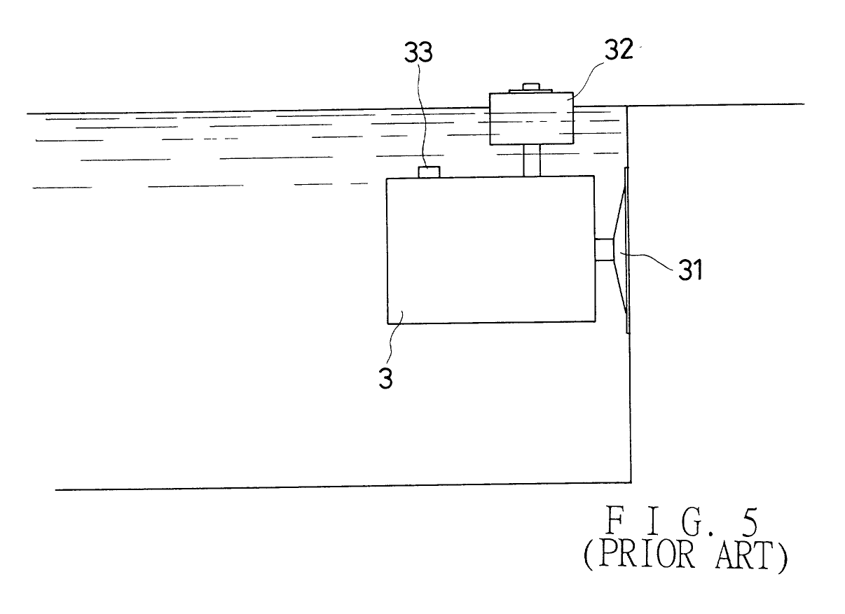

### DETAILED DESCRIPTION OF THE PREFERRED EMBODIMENTS

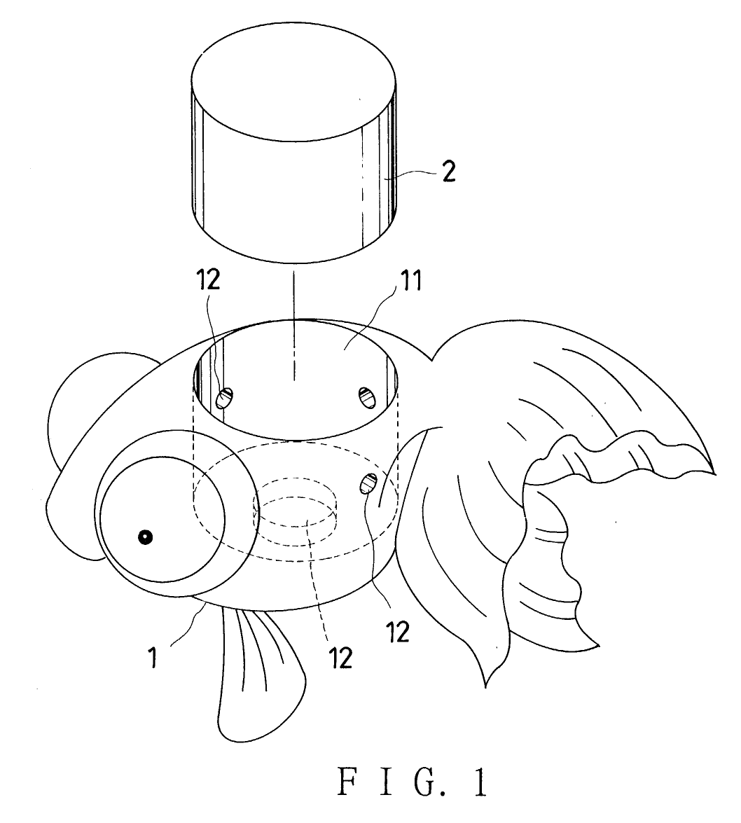

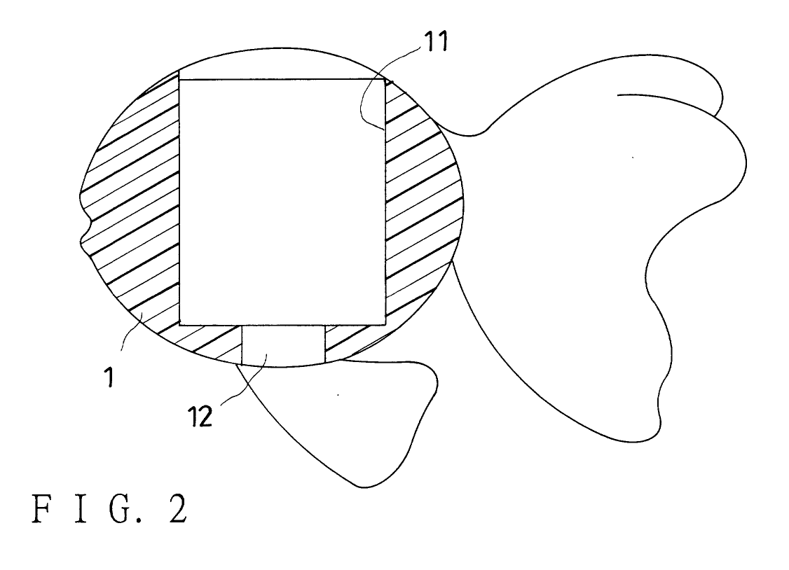

Referring to FIGS. 1 and 2, a floated mist generating humidifier of the present invention includes a housing member 1, and a mist generating member 2.

The housing member 1 has a holding room 11, and a plurality of through holes 12 that communicate with the holding room. The holding room 11 has an upper opening (not numbered). The housing member 1 can be presented with various colors and shapes such as marine animals and ships so that the humidifier is pleasant to look at.

The mist generating member 2 is received in the holding room 11 of the housing member 1 with an upper end portion being disposed in the upper opening of the holding room; the mist generating member 2 is electrically connected to the power supply with cords (not shown), and can generate mist, and send out the mist from the upper end portion thereof when coming into contact with water. The mist generating member 2 is passed through the upper opening of the holding room 11 to be connected to the housing member 1 according to FIG. 1. As an alternative, the holding room 11 can be provided with a bottom opening, and the mist generating member 2 can be passed through the bottom opening to be connected to the housing member 1.

In addition, the housing member 1 is made of materials that are relatively light in weight, and is constructed in such a manner that the humidifier can float on water with the through holes 12 being at least partially submerged under the surface of the water; thus, the mist generating member 2 is made to send out mist through the upper opening of the holding room 11 to the atmosphere by water that flows into the through holes 12 to come into contact with the same.

Furthermore, the mist generating member 2 is disposed closer to the bottom of the housing member 1 than to the top of the same such that the humidifier has a center of gravity closer to the bottom than to the upper side thereof; thus, there is no possibility of the humidifier floating on water upside down.

In using the humidifier of the present invention the humidifier is placed oil the water in a container or all aquarium, of which the water level is high enough for the humidifier to float; thus the mist generating member 2 is activated to send out mist to the air by the water. And, the humidifier can make circular movement due to the connection with the cords when it is made to move along by currents of the. When the water becomes too little to flow into the through holes 12, the mist generating member 2 will stop working automatically.

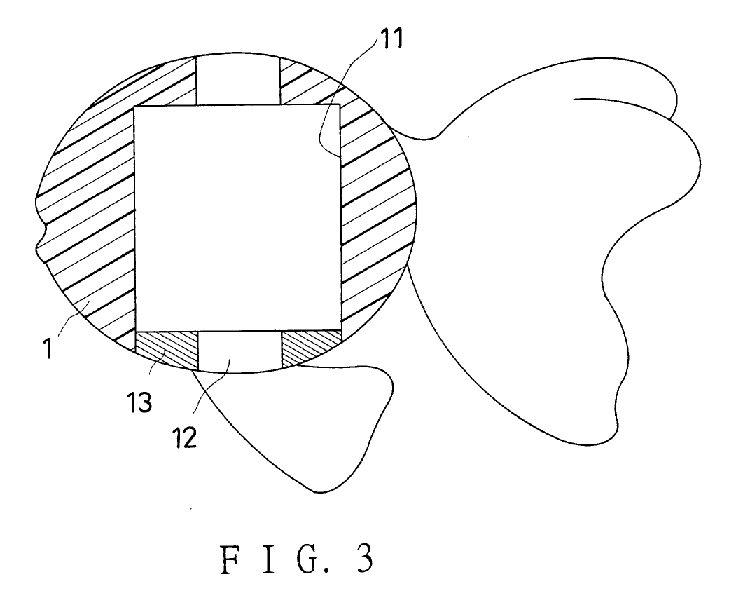

The mist generating member 2 is made to have such a shape that it can be tightly held in the holding room 12 when it is passed into the same. Referring to FIG. 3, adhesives 13 are used to fasten the mist generating member 2 to the housing member 1 according to the second embodiment.

From the above description, it can be easily understood that the floated mist generating humidifier has advantages as followings:

1. Besides the humidifying function, the humidifier can be very entertaining and pleasant to look at due to the circular movement and designs and colors thereof. Therefore, the humidifier can be used as a decoration.

2. The user doesn't have to fit the humidifier to an aquarium or a water container because the humidifier is made to float oil water.

3. The humidifier can generate, and send out, mist as long as there is sufficient water level for the same to float on. Therefore, the user doesn't have to adjust the position of the humidifier when the water level changes.

What is claimed is:

1. A floated mist generating humidifier, comprising
a housing member having a holding room, and a plurality of through holes communicating with the holding room-, the holding room having an upper opening;
a mist generating member received in the holding room of the housing member with an upper end portion being disposed in the tipper opening of the holding room; the mist generating member being capable of generating mist and sending out the mist from the upper end portion thereof when coming into contact with water;
the housing member being made in such a manner that same combined with the mist generating member can float on water with the through holes being at least partially submerged under surface of the water, causing the mist generating member to send out mist through the upper opening to atmosphere.

2. The floated mist generating humidifier of claim 1 wherein tile mist generating member is disposed in the holding room in such a manner that the humidifier has a center of gravity closer to a bottom than to ant upper side thereof, preventing the humidifier from floating on water upside down.

3. The floated mist generating humidifier of claim 1 wherein the mist generating member is electrically connected to a power supply with cords; the humidifier being capable of making circular movement due to the connection with the cords when it is made to move along by currents of water which it is disposed on.

4. The floated mist generating humidifier of claim 1, wherein the housing member is made to have shapes of marine animals.

5. The floated mist generating humidifier of claim 1, wherein the mist generating member is passed through the upper opening of the holding room to be connected to the housing member.

6. The floated mist generating humidifier of claim 1, wherein the holding room has a bottom opening, and the mist generating member is passed through the bottom opening of the holding room to be connected to the housing member.

7. The floated mist generating humidifier of claim 1, wherein the mist generating member is shaped such that it can be tightly held in the holding room when it is passed into the same.

8. The floated mist generating humidifier of claim 1, wherein the mist generating member is fastened to the housing member by means of adhesives.
